(19) United States
(12) Patent Application Publication
(10) Pub. No.: US 2004/0035923 A1
(43) Pub. Date: Feb. 26, 2004

(54) Process for acquiring new borrowers by funding bill payment

(76) Inventor: Andrew Kahr, San Francisco, CA (US)

Correspondence Address: GLENN PATENT GROUP, 3475 EDISON WAY, SUITE L, MENLO PARK, CA, 94025, US

(21) Appl. No.: 10/110,591

(22) PCT Filed: Aug. 23, 2001
(86) PCT No.: PCT/US01/26605

(51) Int. Cl. G06F 17/60; G06F 17/00

(52) U.S. Cl. 235/379; 235/375; 705/38

(57) ABSTRACT

The invention provides a process for acquiring new borrowers by a lender, in which the lender arranges with a billor to offer credit to selected payors to pay amounts due on their accounts with the billor. The lender selects from the payors according to criteria based on information from external sources, and their payment history with the billor. Billing documents, such as billing statements, to the targeted payors are customized to include an offer of credit from the lender. A means is provided with the billing document for the payor to accept the offer readily and easily, whereupon the lender debits the amount of the bill to a newly opened credit account for the payor. Terms of the new account may be determined in the selection process, depend on the data used in that process. In a preferred embodiment, the payor agrees to pay all future amounts due the billor through the newly opened account. In this way, using the established relationship between the billor and the payor, a new, independent relationship is established between the payor and the lender. The lender may then issue a credit card or provide other credit access to the payor and will be free to solicit the payor for other credit products and services.

### BACKGROUND OF THE INVENTION

1. Field of the Invention

The invention relates to methods for developing new business in the lending industry. More particularly, the invention relates to a process for establishing new lending relationships by a lender wherein the billing statement of a cooperating merchant or billor is modified so that a targeted payor or consumer can pay the bill by selecting an indicator on the statement and returning it, whereupon the lender advances the amount of the bill and opens a credit account for the consumer.

2. Description of Related Art

Conventionally, consumers and small businesses pay bills by mailing a payment instrument such as a check or money order to the billor, together with a bill stub, which may be appropriately marked. Additionally, automated bill-paying systems involving various types of paperless transactions are becoming more and more common. See, for example, M. Anderson, System and method for paying bills electronically, U.S. Pat. No. 5,283,829 (Feb. 1, 1994), or R. Kolling, W. Powar, Electronic bill pay system, U.S. Pat. No. 5,920,847 (Jul. 6, 1999) or J. Hilt, R. Hodges, S. Pardue, W. Powar, Electronic bill pay system, U.S. Pat. No. 6,032,133 (Feb. 29, 2000). All of these systems allow a consumer to pay bills by debiting the amount of the bill to be paid to an established asset account, such as a checking account. While such systems offer a measure of convenience, the consumer must have the amount of the bill on hand in his asset account—no means is provided whereby the consumer (or small business, for that matter) may borrow to pay the bill.

Some systems have emerged that allow the consumer to have the amount of a bill debited to an existing credit card account. However, the credit card account used for payment must have been previously established, independently of the billor.

Current methods of printing billing statements allow the billing statement to be customized according to the billor's choice of account and customer performance and characteristics, and desired criteria for marketing initiatives. For example, J. Walker, Method and apparatus for printing a billing statement to provide supplementary product sales, U.S. Pat. No. 6,196,458 (Mar. 6, 2001) describes an arrangement in which the various billing items to be printed to a payor's statement may satisfy various merchant-specified upsell offer conditions. The upsells are offered to the account holder by printing indicia on the billing statement that specify the upsells. The account holder accepts any of the offers by appropriately modifying the statement and returning it with payment. While the described arrangement conveniently alerts the account holder to possibly desirable merchandise and provides a convenient means of paying for it, and further provides the various merchants with qualified, motivated prospects, it doesn't provide any means whereby the account holder may borrow to pay the balance on the billing statement, and it is designed to increase business for the billor, rather than helping other lenders to establish relationships with the account holder through which the bill, future bills and other items can be paid or advanced.

Various methods of real-time loan processing and approval, and point-of-sale loan approval are known. See, for example, J. Norris, System and method for real-time loan approval, U.S. Pat. No. 5,870,721 (Feb. 9, 1999) or D. Walker, L. Sussman, M. Mayr, C. Dean, D. Seib, R. Musci, G. Marino, System and method to (sic) performing on-line credit reviews and approvals, U.S. Pat. No. 6,088,686 (Jul. 11, 2000). Furthermore, it is common for retailers to open a charge account for a customer at the point-of-sale. Typically, these systems allow the consumer to obtain a loan for a specific purpose or with a specific merchant. They do not contemplate the establishment of a revolving account that can be used for multiple merchants, and they are not intended to allow the consumer to re-finance trade credit or other debt previously incurred, in order to obtain more flexible, extended terms. Furthermore, this art does not provide for pre-qualification off-line of customers to whom a credit offer is to be made.

It is known to employ credit bureau databases and other information sources to selectively target prospective borrowers or cardholders with customized offers. These programs usually seek simply to open new accounts. They do not contemplate the use of an established relationship between a merchant or billor and a consumer as an entry point for an independent lending relationship between a third party and the consumer, which will be used in the first instance to pay the billor for the current and future bills.

Accordingly, it would significantly advance the art to provide a process for soliciting bill payors, in which the prospective payors have been screened for open-end extended credit on the basis of third party data base information and billor experience characteristics. It would be advantageous to provide a simple, convenient means, using the billing statements of cooperating merchants, that allowed a payor to pay the merchant's bill simply by checking a box, or detaching and sending in a coupon, without tapping an asset account or any established source of credit. Advantageously, a lender could then debit the amount of the bill to a newly opened account and pay the bill. Furthermore, the new account could automatically be used to pay subsequent bills by the same merchant, and could be used by the consumer for any other borrowing via a credit card, checks or other access media, as provided for in the offer.

### SUMMARY OF THE INVENTION

To that end, the invention provides a process for acquiring new borrowers by a lender, in which the lender arranges with a billor to offer credit to selected payors to pay amounts due on their accounts with the billor. The lender selects from the payors according to criteria based on information from external sources, and their payment history with the billor. Billing documents, such as billing statements, to the targeted payors are customized to include an offer of credit from the lender. A means is provided with the billing document for the payor to accept the offer readily and easily, whereupon the lender debits the amount of the bill to a newly opened credit account for the payor. Terms of the new account may be determined in the selection process, depend on the data used in that process. In a preferred embodiment, the payor agrees to pay all future amounts due the billor through the newly opened account. In this way, using the established relationship between the billor and the payor, a new, independent relationship is established between the payor and the lender. The lender may then issue a credit card or provide other credit access to the payor and will be free to solicit the payor for other credit products and services.

### BRIEF DESCRIPTION OF THE DRAWING

FIG. 1 provides a flow diagram of a process for acquiring new borrowers by funding bill payment according to the invention.

### DETAILED DESCRIPTION

The invention provides a process by which lenders, such as banks and credit card issuers, hereinafter referred to as lenders, establish new lending relationships with selected consumers or small businesses, hereinafter referred to as payors, by collaborating with merchants or other entities, hereinafter referred to as billors, that bill the payors. The invention permits any payor selected by a lender to pay the bill of a cooperating billor simply by returning a coupon enclosed with the statement or checking a box provided on the statement, whereupon the amount due is advanced by the lender. This new loan account can be used for automatic payment of all future bills by this payor to this billor. Lending the payor the money to pay the bill also serves to establish an independent relationship between the payor and the lender, who may provide the payor with extended and more flexible credit through a bankcard or other product.

The invention employs software-driven methods for mass-customization of various documents sent to payors. In the preferred embodiment of the invention, a printing device, such as a laser printer, controlled by appropriate software, individualizes the content of billing documents according to a predetermined combination of account and payor performance and any other desired criteria for receipt of marketing initiatives from the lender. One skilled in the art will appreciate that the invention allows various versions of the billing documents to be created; for example, a standard version to be sent to the general population of payors and another version to be sent to a sub-population of payors that have been targeted by the lender in the manner previously described. Some payors may qualify only for the offer of a small amount of expensive, single-purpose sub prime credit, while others may qualify for a bankcard account with high credit line and advantageous terms. The invention utilizes external information sources, such as credit bureau databases, along with information provided by the billor, such as payment history, to aid in the selection of payors to be targeted and of the offers to be made to them. Such methods are known to those skilled in the art. Billing documents sent to targeted payors are customized to include an offer of credit from the lender.

Criteria for extending offers are highly flexible. For example, payors who pay at least some bills on time and/or who appear to pay interest on at least some unsecured obligations may be targeted.

Additionally, a means is provided for the payor to accept the offer quickly and conveniently. In one embodiment of the invention, a checkbox, or other selectable indicator is provided. By selecting the indicator and returning the billing document without payment, the payor accepts the offer. In an alternative embodiment, a special coupon is provided, either as a separate document or detachable from the billing document, in addition to the coupon normally attached to billing statements. By returning the special coupon, without payment, the payor accepts the offer. A related patent application by the current inventor, Multiple coupons for providing alternative terms for offers, satisfaction of financial obligations or promotions, U.S. patent application Ser. No. 09/613,790 (Jul. 29, 1999) describes a method that employs such coupons.

While the above description has been directed to paper documents, typically delivered to the payor via surface mail, electronic documents are entirely consistent with the spirit and scope of the invention. The generation of such documents is completely software-driven, not requiring even a printing device. In such embodiment, the billing documents may be delivered to the payor's e-mail account or bill payment vendor over a publicly accessible telecommunications network such as the Internet.

The terms of the offer may include an introductory interest rate; for example, no interest for a period such as thirty or ninety days, with full payment due at the end of the introductory period, subject to a late fee and back interest due if this payment is not made. Furthermore, the offer may include required disclosures of the lender's credit terms.

Depending on the size of the bill and the lender's underwriting policies, payors accepting the offer may be underwritten for extended or additional credit. Required telephone contact may form part of this underwriting process. Payors who fail underwriting may be required to pay promptly and in full.

As soon as possible after the payor accepts the lender's offer, the lender solicits the payor, if he is qualified, directly for additional credit related services and loan products.

The lender may use telephone contact, e-mail or conventional surface mail to contact the payor. The solicitation may be for extended credit if the initial credit offer was for an introductory period, and/or the solicitation may be for the issuance of a bank credit card or other revolving credit vehicle to which the initial balance would be transferred at an appropriate time, if the original offer did not include these elements. Additionally, the lender may solicit to provide balance transfers, cash advances, and protection and other services.

It will be appreciated that billing documents usable for solicitation of borrowers can include statements and invoices, as well as late notices, demands for payment, and any other notice or document sent to the payor by the billor regarding payment of amounts due on the payor's account.

The invention offers the important advantage of allowing lenders to solicit payors on the basis of third-party supplied information as well as billor experience and to acquire the payor as a borrower when the payor takes a simple action that is much more convenient and much more advantageous to the payor than merely writing a check (or providing credit card information) to pay the billor's bill. There are no incremental mailing costs, the billors prospects of prompt payment of this and later bills are greatly enhanced, thus reducing credit losses and delinquency costs, and the probability of retaining the customer and of making additional sales to him is also increased because the customer becomes less conscious of his payments to the billor.

Information about the extended credit offer is provided on the back of a payment coupon, or elsewhere on or with the billing document. Accordingly, the payor merely needs to tear off a coupon or check a box on the billing document in order to accept. No signature or additional information need be provided by the payor when he accepts, and no payment of any kind needs to be enclosed with the returned statement or coupon. The result is the opening of a loan or credit card account by the lender for the payor, with payment of the billor's bill by the lender debited to the new account, and with future bills also to be debited to this account.

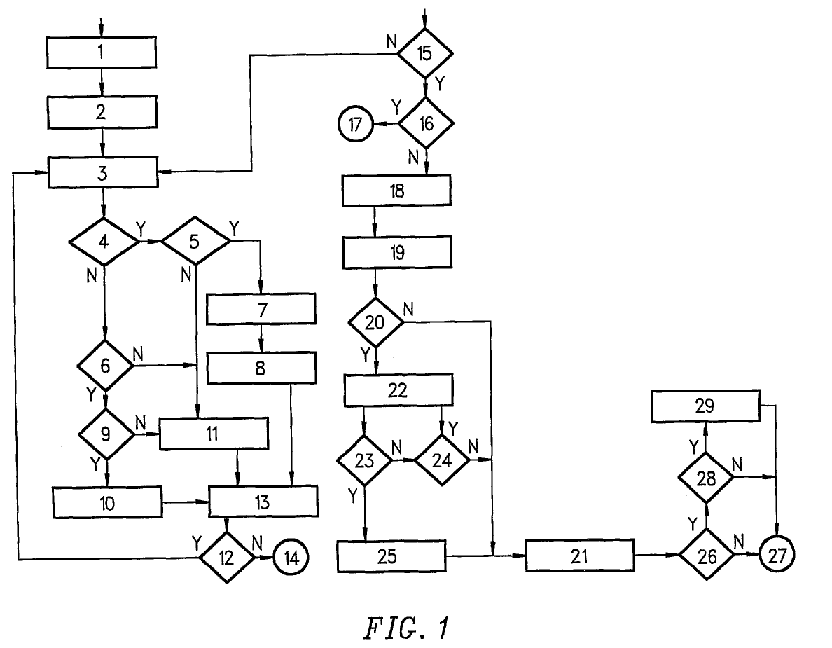

Turning to FIG. 1, a flow diagram of the invented process is provided. According to the invention, the lender solicits one or more billors and arranges with the billor to solicit the billors customers (payors) (Step 1). Examples of such billors include utilities, insurance companies, providers of cable TV, Internet and other such services that do not offer extended credit terms, and taxing authorities. The proposed relationship with the lender provides the billor with several important advantages: more rapid payment of bills with fewer delinquencies and credit losses, and complete or partial payment by the lender of costs related to statementing. For example, once an account is opened for a payor, the lender may advance payment to the billor at the time the bills are sent. In one embodiment of the invention, the billor is also paid a predetermined amount for each new borrower acquired by the lender as a result of the relationship with the billor. Thus, the relationship with the lender has a salutary effect on the billor's cash flow, both by accelerating and assuring bill payment, and by providing an additional revenue stream. The additional credit and the automated payment provided by lender also tend to increase payor purchases from billor and the duration of payor's relationship with billor.

Following establishment of the relationship between the billor and the lender, the lender formulates selection and action criteria for credit offers (Step 2). These criteria may utilize account information available from billor and results of previous solicitations for this or other services, as well as screening data provided by credit bureaus or other external sources and by lender. They may result in selection of individual payors in a particular billing cycle for no offer, for any of several offers, or for a customized offer. Payors who are already customers of lender may receive an offer to have their bills automatically debited to an existing or new account with lender.

Utilizing the criteria provided by the lender, for each billing cycle, payors are evaluated in a stepwise manner to determine what type of billing document they should receive:

Pending statements are distinguished from demands for payment (Step 3). While demands for payment may not be excluded from the pool of those targeted to receive marketing initiatives from the lender, it is desirable that they be handled separately, since they are likely to show both greater need for credit and greater risk. Where appropriate, references below to “statements” should be taken to include any other documents regularly sent to groups of customers, such as demands for payment, newsletters, promotional mailings or statements of terms of service.

It is ascertained whether the payor is already a customer of the lender through this program (Step 4);

For a payor that is already a customer of the lender, it is determined if the payor has sufficient credit with the lender to pay the bill (Step 5); if so,

The lender is notified, and a payment scheduled (Step 7) after which;

A statement providing for automatic debiting of the amount of the bill to the account with the lender is specified (Step 8); and

The statement is printed, inserted in an envelope and mailed (Step 13). This statement may include additional options or offers from the lender, or it may provide for payment to the lender account. If appropriate it may be marked “DO NOT PAY.”

Returning to Step 4:

If the payor is not a customer of the lender under this program:

The payor is screened first against the billor's exclusion criteria, if any (step 6). For instance, the billor may wish to exclude large or VIP customers from this program, or those who pay frequent and lucrative late fees.

For payors who pass this screen, do external data, combined with billor and any relevant lender data qualify the payor for solicitation, according to the criteria set by the lender? (Step 9);

The lender criteria are further applied to select the terms to be offered to the payor, the appropriate marketing message, along with any enclosure to be sent with the statement or any change in the statement or other form such as an additional coupon; then the printing file is set (Step 10);

The statement is printed, inserted in an envelope and mailed (Step 13). Note that customers who are receiving a statement or other mailing from billor may be selected for and enrolled in this credit program even if there is, at the time, no balance due.

Returning to Step 6:

If the payor is excluded by billor, the print file is set for a standard bill (Step 11); The statement is printed, inserted in an envelope and mailed (Step 13).

Returning to Step 9:

If the external data and the internal data do not qualify the payor for a lender solicitation, the print file is also set for a standard bill (Step 11); and

The statement is printed, inserted in an envelope and mailed (Step 13).

As each statement is finished:

It is determined if there are more accounts to be processed (Step 12).

If yes, process flow returns to Step 3;

If no, the mailing cycle is terminated (Step 14).

At a later time, responses from customers who have received or accepted an offer from lender are evaluated (Step 15);

If the payor hasn't responded, a demand for payment or subsequent statement will be generated at the next billing or collection cycle depending upon whether or not the payor is already enrolled in the program (Step 3);

If the payor responds, it is determined if he has enclosed payment (Step 16);

If payment is enclosed, the payment is processed in the normal manner. If the payor is already enrolled in this program, the lender is notified and an adjustment is made to the lender's payment account with the billor, (Step 17);

If no payment is enclosed, the billor notifies the lender (Step 18); and

The lender contacts the payor if necessary to ascertain his intentions, opens a borrowing account for the payor as indicated by the payor and pays the billor (Step 19); whereupon

The lender underwrites the account to determine if the payor qualifies for continuing credit (Step 20);

If not, the lender services the loan as needed, and may solicit the payee again at some future time (Step 21). The contract between lender and billor may provide for assignment of collection responsibility in these situations and for any appropriate reimbursement by billor of lender losses on accounts that fail underwriting criteria.

Returning to Step 20:

If the payor passes underwriting, the lender provides appropriate fulfillment (which may include a credit card) and disclosures to the payor, opens the appropriate account or accounts, and solicits the payor once or repeatedly, by phone, mail or other means for a broader credit relationship and balance transfers or other services (Step 22);

If the payor accepts any of these propositions, the lender fulfills the terms of the additional offers, completes balance transfers; sends a credit card (if not already sent) and any other mailings (Step 25); and

The lender services the loan as needed, and may solicit the payee again at some future time (Step 21).

Returning to Step 23:

If the payor does not accept, the lender will re-solicit at another time (Step 24); if the payor accepts at that time, the lender proceeds with Step 25;

In the course of loan service (Step 21) the payor may default or otherwise fail to make payment on the loan (Step 26):

If so, it is decided pursuant to the terms of the contract between billor and lender and the terms of the loan whether the billor will suspend provision of goods or services (Step 28);

If not, the billor continues servicing and marketing to the payor (Step 27), and the billor may become responsible for credit losses as provided by contract.

Returning to Step 28:

As required or allowed by the applicable contracts, the billor suspends sales and service to the delinquent payor (Step 29);

Following suspension of sales and service to the delinquent payor, at some future time, after the account is brought current, or after the lender and the payor have agreed to terms, credit for purchases by payor from billor may again be provided by billor or lender (Step 27).

While the process has been described above with respect to pending statements on accounts that are current, a similar process is applied to prepare customized late notices and letters sent on behalf of the billor to payors who have not paid their last bill on time, or who otherwise qualify to receive a communication from billor.

As previously indicated, the invention is either completely or largely automated, being executed on one or more data processing devices or networks of data processing devices under the control of appropriate computer programs. The invented process is implemented using conventional programming techniques and using commonly known programming languages.

Although the invention has been described herein with reference to certain preferred embodiments, one skilled in the art will readily appreciate that other applications may be substituted without departing from the spirit and scope of the present invention. Accordingly, the invention should only be limited by the claims included below.

1. A process for acquiring new borrowers by a lender, comprising the steps of:
sending a document to a holder of a first account by issuer of the account, wherein the issuer is a billor,
with the document, providing an offer, by the lender, of credit for one or more of:
paying an amount due on the first account, paying amounts to be due and general use;
accepting, by the payor, the offer; and
debiting the amount due to a new account issued by the lender;
so that the payor and the lender establish a relationship independent of the billor.

2. The process of claim 1, wherein the document comprises any of:
periodic billing statements;
late payment billing documents;
late payment demand documents; and
correspondence related to the first account.

3. The process of claim 1, further comprising the step of:
providing required disclosures with the document.

4. The process of claim 1, further comprising the step of:
targeting the payor according to predetermined criteria.

5. The process of claim 4, wherein the step of targeting the payor comprises the steps of:
providing a list of payors to the lender by the billor;
screening the list of payors against one or more criteria, the criteria comprising:
billor's payment records, credit bureau records, and external and lender data sources; and
selecting payors to whom the lender's offers will be made.

6. The process of claim 5, wherein said step of providing a list of payors to the lender further comprises the step of:
excluding payors from the list whom the billor does not wish to have solicited by or for the lender.

7. The process of claim 5, wherein the billor provides the list of account holders at every payment cycle.

8. The process of claim 5, wherein the step of providing an offer of credit comprises the steps of:
customizing the document to the targeted payor, wherein the offer is included either in the body of the billing document or separate from the billing document and terms of the offer may depend on the screening criteria; and
providing means for accepting the offer readily.

9. The process of claim 8, wherein the means for accepting the offer readily comprises either a selectable indicator within the document or a coupon, wherein the payor chooses the coupon.

10. The process of claim 8, wherein the coupon is either separate from the billing document or detachable from the billing document.

11. The process of claim 8, wherein the selectable indicator comprises a checkbox.

12. The process of claim 8, wherein the billing document comprises either a paper document or an electronic document.

13. The process of claim 8, wherein the step of accepting the offer comprises either of:
selecting the indicator and returning the billing document; and
returning the coupon.

14. The process of claim 13, further comprising the steps of:
underwriting the account by the lender upon return of the coupon; and
if the account is rejected, refusing the credit or further credit.

15. The process of claim 1, further comprising the step of:
automatically debiting subsequent amounts due the billor to the new account.

16. The process of claim 1, further comprising the step of:
directly billing the account holder for a subsequent amount due the billor when credit with the lender is unavailable.

17. The process of claim 1, further comprising one or both of the steps of:
suspending provision of further goods and services by the billor in the event the payor fails to pay amounts due the lender; and
resuming provision of goods and services when amounts due the lender are paid by the payor or with the consent of lender.

18. The process of claim 1, further comprising the step of:
compensating the billor by the lender.

19. The process of claim 18, wherein the step of compensating the billor comprises any of the steps of:
paying a predetermined amount for each new borrower;
subsidizing billing costs; and
making periodic payments.

20. The process of claim 1, further comprising the steps of:
charging the billor for losses on accounts which fail underwriting; and
charging the billor for losses on accounts which continue to make purchases from billor after failing to make payments to lender,

21. The process of claim 1, further comprising the steps of:
providing by the lender to the payor one or more of a credit card, a bank card and access to additional borrowings, in accordance with the terms of its initial offer; and
subsequently soliciting the payor directly for additional credit related services.

22. The process of claim 1, wherein the billor comprises any of:
a utility;
an insurance company;
any service vendor that doesn't offer extended credit terms;
a taxing authority;
any entity to which payments are due that doesn't offer extended credit terms; and
any entity to which payments are due that prefers that extended terms be provided to payors by an external source of credit.

23. A computer program product for acquiring new borrowers by a lender, said computer program product comprising a computer usable storage medium having computer readable computer code means embodied in the medium, the computer code means comprising computer readable program code means for:
sending a document to a holder of a first account by issuer of the account, wherein the issuer is a billor,
with the document, providing an offer, by the lender, of credit for one or more of:
paying an amount due on the first account, paying amounts to be due and general use;
accepting, by the payor, the offer; and
debiting the amount due to a new account issued by the lender;
so that the payor and the lender establish a relationship independent of the billor.

24. The computer program product of claim 23, wherein the document comprises any of:
periodic billing statements;
late payment billing documents;
late payment demand documents; and
correspondence related to the first account.

25. The computer program product of claim 23, further comprising computer readable code means for:
providing required disclosures with the document.

26. The computer program product of claim 23, further comprising computer readable code means for:
targeting the payor according to predetermined criteria.

27. The computer program product of claim 26, wherein the computer readable code means for targeting the payor computer readable code means for:
providing a list of payors to the lender by the billor;
screening the list of payors against one or more criteria, the criteria comprising:
billor's payment records, credit bureau records, and external and lender data sources; and
selecting payors to whom the lender's offers will be made.

28. The computer program product of claim 27, wherein the computer readable code means for providing a list of payors to the lender further comprises computer readable code means for:
excluding payors from the list whom the billor does not wish to have solicited by or for the lender.

29. The computer program product of claim 27, wherein the billor provides the list of account holders at every payment cycle.

30. The computer program product of claim 27, wherein the computer readable code means for providing an offer of credit comprises computer readable code means for:
customizing the document to the targeted payor, wherein the offer is included either in the body of the billing document or separate from the billing document and terms of the offer may depend on the screening criteria; and
providing means for accepting the offer readily.

31. The computer program product of claim 30, wherein the means for accepting the offer readily comprises either a selectable indicator within the billing document or a coupon, wherein the payor chooses the coupon.

32. The computer program product of claim 30, wherein the coupon is either separate from the billing document or detachable from the billing document.

33. The computer program product of claim 30, wherein the selectable indicator comprises a checkbox.

34. The computer program product of claim 30, wherein the billing document comprises either a paper document or an electronic document.

35. The computer program product of claim 30, wherein the computer readable code means for accepting the offer comprises computer readable code means for either of:
selecting the indicator and returning the billing document; and
returning the coupon.

36. The computer program product of claim 35, further comprising computer readable code means for:
underwriting the account by the lender upon return of the coupon; and
if the account is rejected, refusing the credit or further credit.

37. The computer program product of claim 23, further comprising computer readable code means for:
automatically debiting subsequent amounts due the billor to the new account.

38. The computer program product of claim 23, further comprising computer readable code means for:
directly billing the account holder for a subsequent amount due the billor when credit with the lender is unavailable.

39. The computer program product of claim 23, further comprising computer readable code means for one or both of:
suspending provision of further goods and services by the billor in the event the payor fails to pay amounts due the lender; and
resuming provision of goods and services when amounts due the lender are paid by the payor or with the consent of lender.

40. The computer program product of claim 23, further comprising computer readable code means for:
compensating the billor by the lender.

41. The computer program product of claim 40, wherein the computer readable code means for compensating the billor comprises computer readable code means for any of:
paying a predetermined amount for each new borrower;
subsidizing billing costs; and
making periodic payments.

42. The computer program product of claim 23, further comprising computer readable code means for:
charging the billor for losses on accounts which fail underwriting; and
charging the billor for losses on accounts which continue to make purchases from billor after failing to make payments to lender,

43. The computer program product of claim 23, further comprising computer readable code means for:
providing by the lender to the payor one or more of a credit card, a bank card and access to additional borrowings, in accordance with the terms of its initial offer; and
subsequently soliciting the payor directly for additional credit related services.

44. The computer program product of claim 23, wherein the billor comprises any of:
a utility;
an insurance company;
any service vendor that doesn't offer extended credit terms;
a taxing authority;
any entity to which payments are due that doesn't offer extended credit terms; and
any entity to which payments are due that prefers that extended terms be provided to payors by an external source of credit.
